(19) United States
(12) Patent Application Publication
(10) Pub. No.: US 2012/0110761 A1
(43) Pub. Date: May 10, 2012

(54) IN-LINE SONDE CARRIER

(76) Inventors: Robert M. Ripperger, Cincinnati, OH (US); Mark Bartlett, Cincinnati, OH (US); John E. Knolle, Cincinnati, OH (US); Michael L. Pittinger, Cincinnati, OH (US)

(21) Appl. No.: 12/939,199

(22) Filed: Nov. 4, 2010

(51) Int. Cl. B08B 9/027

(52) U.S. Cl. 15/104.05; 134/22.11

(57) ABSTRACT

Plumbing snakes, in-line carriers for sondes, and techniques for using the same are disclosed. Some example in-line sonde carriers may include proximal couplings for releasably connecting to plumbing snakes; elongated sonde carrying sections; distal couplings mounted to the sonde carrying sections; tools including tool couplings configured to releasably engage the distal couplings of the sonde carrying sections; and sonde tether assemblies, including retainers shaped to be received and captured within the proximal couplings, elongated, flexible tethers coupled to and extending distally from the retainers, and sondes coupled to and extending distally from the tethers. In some example embodiments, the tethers and the sondes of the sonde tether assemblies may be received within the sonde carrying sections via insertion through axial through-passages of the proximal couplings.

### BACKGROUND

The present disclosure is directed to sewer and/or drain clearing devices and, more particularly, to power-driven sewer and/or drain clearing devices, also known as plumber's snakes, which may be configured to carry locating sondes, and methods of using the same.

The present disclosure contemplates that snakes may be used to locate and/or clear partial and/or complete blockages in pipes, such as drain pipes and sewer lines. Some snakes may comprise flexible lengths of coiled metal wire, which may be generally in the form of helical coil springs. The flexible lengths comprising the snake may be coupled together, end-to-end, and/or may be inserted into a clogged pipe, such as via a clean-out fitting in a drain pipe. The snake may be propelled by a powered snake machine, which may be configured to rotate the snake about its longitudinal axis while progressively driving the snake into or withdrawing the snake from the pipe.

The present disclosure contemplates that it may be desirable to identify the location of buried pipes and, in particular, it may be desirable to identify the location of a blockage in an underground pipe. In some cases, the location of a blockage may determine the party responsible for the cost of clearing the blockage. For example, property owners may be responsible for blockages occurring on their property, and a municipality may be responsible for blockages occurring in sewer laterals and mains. Also, for a blockage that cannot be cleared using a snake, it may be desirable to determine the location of a blockage to reduce the extent of excavation required to access the blocked portion of the pipe.

The present disclosure contemplates that sondes, such as radio sondes configured to emit a radio signal at a predetermined frequency, may be used to locate buried pipes and/or blockages within buried pipes. For example, a snake may be inserted into a clogged pipe until the distal end of the snake reaches a blockage. If the blockage is not readily cleared, it may be desirable to ascertain the location of the blockage. Thus, the snake may be withdrawn from the pipe, a sonde may be attached to the snake, and the snake may be inserted into the pipe until the sonde reaches the blockage. Then, the location of the sonde (e.g., the location of the blockage) may be determined using a radio-locating device configured to cooperate with the sonde.

The following U.S. Patent and U.S. Patent Application Publications may be relevant to the present disclosure and are incorporated by reference into this Background section: U.S. Pat. No. 7,298,126; U.S. Patent Application Publication No. 2006/0155168; U.S. Patent Application Publication No. 2009/0166035; and U.S. Patent Application Publication No. 2009/0300863.

### SUMMARY

Example embodiments may include plumbing snakes, in-line carriers for sondes, and techniques for using the same. Some example in-line sonde carriers may include proximal couplings for releasably connecting to plumbing snakes; elongated sonde carrying sections; distal couplings mounted to the sonde carrying sections; tools including tool couplings configured to releasably engage the distal couplings of the sonde carrying sections; and sonde tether assemblies, including retainers shaped to be received and captured within the proximal couplings, elongated, flexible tethers coupled to and extending distally from the retainers, and sondes coupled to and extending distally from the tethers. In some example embodiments, the tethers and/or the sondes of the sonde tether assemblies may be received within the sonde carrying sections via insertion through axial through-passages of the proximal couplings.

In an aspect, an in-line sonde carrier for a plumbing snake may include a proximal coupling for releasably connecting to a distal end of a plumbing snake, the proximal coupling including an axial through-passage; an elongated sonde carrying section constructed of coiled metal wire, the sonde carrying section being mounted to the proximal coupling; a distal coupling mounted to the sonde carrying section; a tool including a tool coupling configured to releasably engage the distal coupling of the sonde carrying section; and a sonde tether assembly, including a retainer shaped to be received and captured within the proximal coupling, and an elongated, flexible tether coupled to and extending distally from the retainer, the tether being adapted to mount to a sonde extending distally from the tether; where the tether and the sonde of the sonde tether assembly may be received within the sonde carrying section via insertion through the axial through-passage of the proximal coupling.

In a detailed embodiment, the proximal coupling may include a proximally opening, axially oriented generally hexagonal cavity for receiving therein a corresponding distally extending, generally hexagonal section of a distal coupling of the plumbing snake. In a detailed embodiment, the proximal coupling may include a generally radially oriented, cylindrical opening extending from the hexagonal cavity for receiving therein a spring-biased locking pin extending generally radially from the hexagonal section of the distal coupling of the plumbing snake.

In a detailed embodiment, the sonde carrying section may comprise a distal, relatively smaller diameter portion and a proximal, relatively larger diameter portion and/or the tether and the sonde may be received substantially within the proximal, relatively larger diameter portion. In a detailed embodiment, the tether may comprise a helical coil spring. In a detailed embodiment, the retainer may comprise a distal, relatively smaller diameter section sized to be received within the axial through-passage of the proximal coupling and a proximal, relatively larger diameter section too large to pass through the axial through-passage. In a detailed embodiment, the tool may comprise a blade cutter. In a detailed embodiment, the proximal coupling and the distal coupling may be threadedly engaged with the sonde-carrying section.

In an aspect, a plumbing snake system may include an elongated, flexible plumbing snake including a distal end; a snake distal coupling mounted to the distal end of the snake; and an in-line sonde carrier including a sonde carrier proximal coupling configured to releasably connect to the snake distal coupling, an elongated, flexible sonde-carrying section extending distally from the sonde carrier proximal coupling, a sonde carrier distal coupling extending distally from the sonde-carrying section, a tool including a tool coupling configured to releasably connect to the sonde carrier distal coupling, a sonde tether assembly including a tether and a sonde received axially within the sonde-carrying section via a through-passage in the sonde carrier proximal coupling.

In a detailed embodiment, the sonde carrier proximal coupling may include a proximally opening cavity; and the snake distal coupling may comprise a distally extending section configured to be received within the proximally opening cavity of the sonde carrier proximal coupling to releasably connect the in-line sonde carrier to the snake. In a detailed embodiment, the proximally opening cavity of the sonde carrier proximal coupling may comprise a generally axially oriented, generally hexagonal cavity; and the distally extending section of the snake distal coupling may include a generally hexagonal section configured to be received within the hexagonal cavity of the sonde carrier proximal coupling. In a detailed embodiment, the sonde carrier proximal coupling may include a generally radially oriented opening extending from the proximally opening cavity; and the distally extending section of the snake distal coupling may include a biased locking pin extending generally radially, the locking pin being configured to be received within the radially oriented opening when the distally extending section is installed within the proximally opening cavity.

In a detailed embodiment, the sonde-carrying section may be constructed from coiled metal wire. In a detailed embodiment, the sonde-carrying section may comprise a distal, relatively smaller diameter portion and a proximal, relatively larger diameter portion. In a detailed embodiment, the tether may hold the sonde within the proximal, relatively larger diameter portion of the sonde-carrying section.

In an aspect, a method of using a plumbing snake may include installing a sonde tether assembly including a sonde into an in-line sonde carrier through an axial through-passage in a proximal coupling of the in-line sonde carrier; connecting the proximal coupling of the in-line sonde carrier to a distal coupling of a plumbing snake, thereby capturing a portion of the sonde tether assembly within the proximal coupling of the in-line sonde carrier; and inserting the in-line sonde carrier and the snake into a pipe.

In a detailed embodiment, a method may include mounting a tool to the in-line sonde carrier by connecting a tool coupling affixed to the tool to a distal coupling of the in-line sonde carrier. In a detailed embodiment, the inserting operation may include inserting the in-line sonde carrier and the snake into the pipe until the in-line sonde carrier reaches a blockage in the pipe and/or the method may include determining a location of the sonde using a receiver. In a detailed embodiment, a method may include at least partially clearing the blockage using the tool.

In a detailed embodiment, the connecting operation may include depressing a locking pin extending generally radially from a hexagonal section extending distally from the distal coupling of the snake; inserting the hexagonal section into a proximally opening, axially oriented, hexagonal cavity in the proximal coupling of the in-line sonde carrier; extending the locking pin into a generally radially oriented opening in the proximal coupling of the in-line sonde carrier.

### BRIEF DESCRIPTION OF THE DRAWINGS

The detailed description refers to the following figures in which:

FIG. 1 is an elevation view of an example in-line sonde carrier;

FIG. 2 is a partially exploded view of an example in-line sonde carrier, a sonde tether assembly, and a snake;

FIG. 3 is a schematic view of an example in-line sonde carrier coupled to a power-driven snake;

FIG. 4 is an elevation view of an example sonde tether assembly;

FIG. 5 is a perspective view of an example in-line sonde carrier proximal coupling;

FIG. 6 is a perspective view of an example in-line sonde carrier proximal coupling;

FIG. 7 is a perspective view of an example in-line-sonde carrier proximal connector with a sonde tether assembly partially installed;

FIG. 8 is a perspective view of an example in-line sonde carrier proximal coupling with a sonde tether assembly fully installed;

FIG. 9 is a perspective view of an example snake distal end coupling;

FIG. 10 is an elevation view of an example snake distal end coupling; and

FIG. 11 is an exploded view of an example in-line sonde carrier distal end coupling and tool; all in accordance with at least some examples of the present disclosure.

### DETAILED DESCRIPTION

The present disclosure includes, inter alia, sewer and/or drain clearing devices and, more particularly, power-driven sewer and/or drain clearing devices, also known as plumber's snakes, which may be configured to carry locating sondes, and methods of using the same.

Some example embodiments according to the present disclosure may comprise an in-line sonde carrier, which may be installed between the distal end of a snake and the tool. Some example embodiments may allow the snake to carry both the sonde and the tool simultaneously, thereby allowing locating and clearing a blockage while snaking the pipe only once.

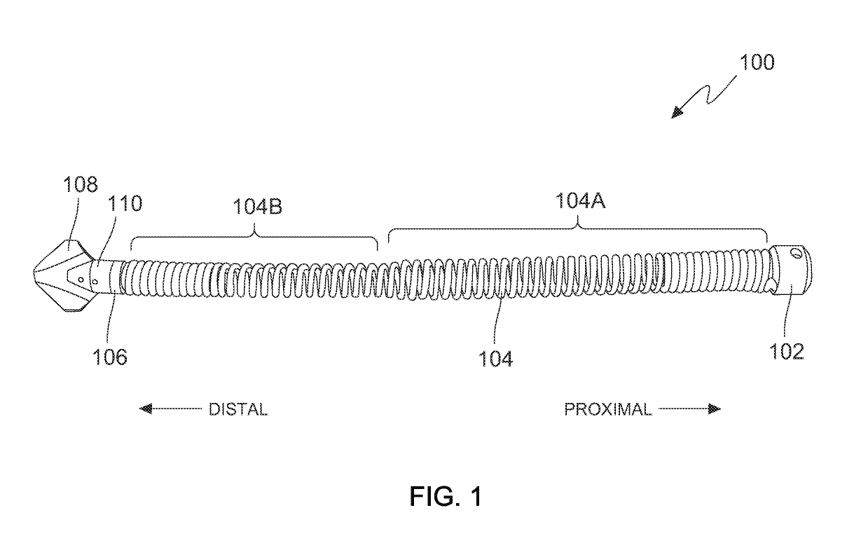

FIG. 1 illustrates an example in-line sonde carrier 100, which may include an in-line sonde carrier proximal end coupling 102, a sonde-carrying section 104 extending distally from the proximal end coupling 102, and an in-line sonde carrier distal end coupling 106 mounted to a distal end of the sonde-carrying section. A tool 108 may be mounted to the distal end coupling 106 using a corresponding tool coupling 110.

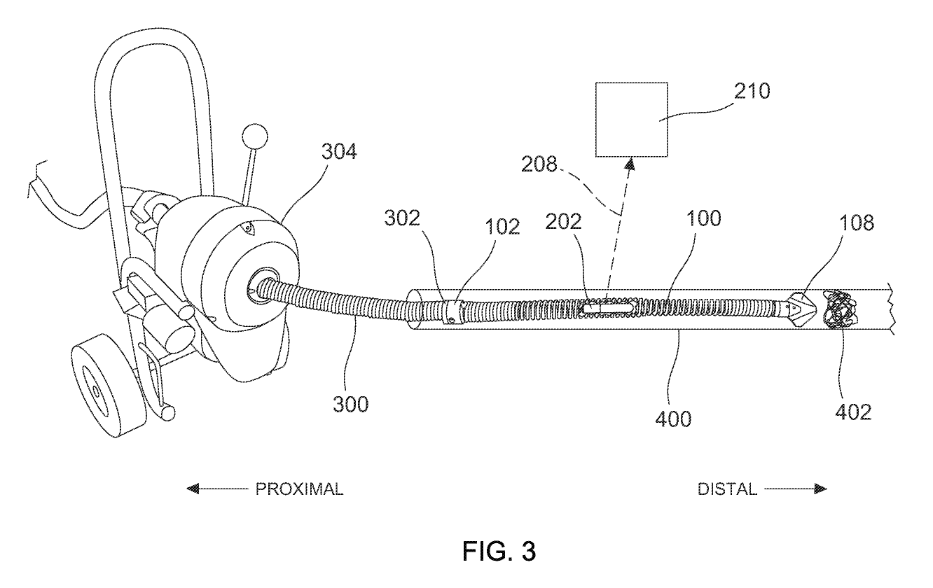

In some example embodiments, sonde-carry section 104 may be constructed from a flexible length of coiled metal wire generally similar to the flexible lengths of coiled metal wire, which may be generally in the form of helical coil springs, that are used in plumbing snakes. In some example embodiments, sonde-carrying section 104 may include portions having different diameters. For example, sonde-carrying section 104 may include a proximally located, expanded diameter section 104A and/or a distally located, smaller diameter section 1048. In one example embodiment, expanded diameter section 104A may have an outer diameter of about 1 7/16 inches and/or smaller diameter section 1048 may have an outer diameter of about 1 7/32 inches (which is about the same diameter as the snake section 300—see FIG. 3). In some example embodiments, expanded diameter section 104A may have a diameter greater than a diameter of a corresponding snake and/or expanded diameter section 104A may have an internal diameter adapted to receive a sonde therein. Sonde-carry section 104 may be substantially bendable to allow passage through fittings, pipe elbows, and the like.

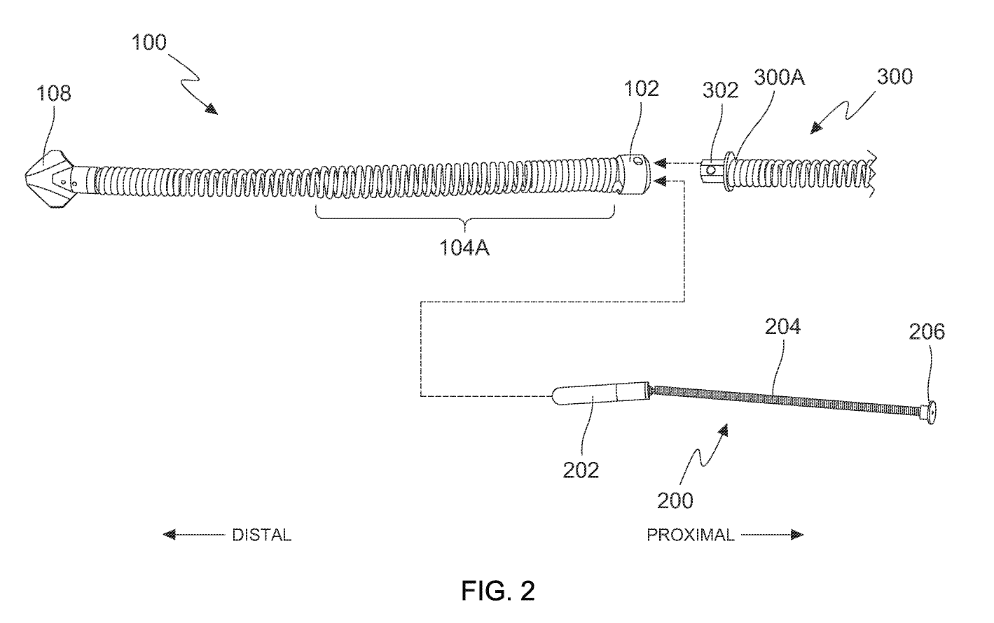

FIG. 2 is a partially exploded view of an example in-line sonde carrier 100, a sonde tether assembly 200, and a snake 300. An example sonde tether assembly 200 may include a sonde 202 (such as a radio sonde) which may be mounted to the distal end of a flexible, elongated tether 204. A retainer 206 may be mounted to the proximal end of tether 204. Snake 300 may include a snake distal end coupling 302 at a distal end 300A of snake 300, which may be configured to releasably engage sonde carrier proximal end coupling 102.

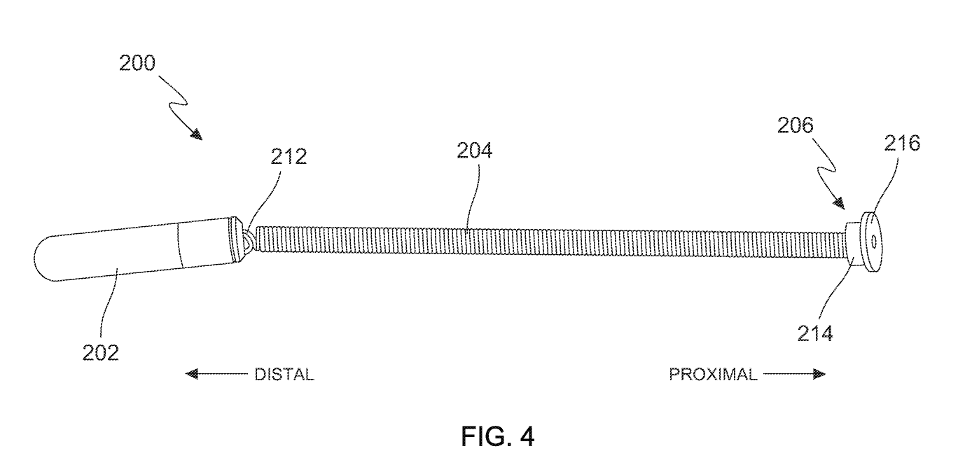

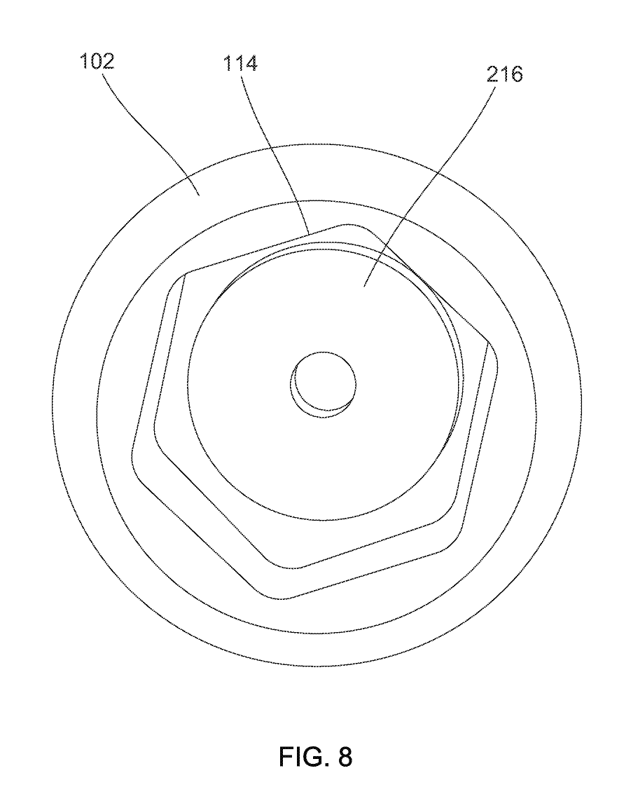

Sonde tether assembly 200, including sonde 202, may be mounted within in-line sonde carrier 100 by inserting sonde tether assembly 200 through sonde carrier proximal end coupling 102. In some example embodiments, sonde tether assembly 200 may be configured to position sonde 202 near the distal end of expanded diameter section 104A of sonde-carrying section 104 when retainer 206 is within sonde carrier proximal end coupling 102 as will be described below with reference to FIGS. 4 and 8. Then, in-line sonde carrier 100 may be mounted to snake 300 by engaging sonde carrier proximal end coupling 102 with snake distal end coupling 302, which may operate to trap retainer 206 of sonde tether assembly between sonde carrier proximal end coupling 102 and snake distal end coupling 302.

FIG. 3 is a schematic view of an example in-line sonde carrier 100 mounted to the distal end of a power-driven snake 300. Snake 300 may be propelled by snake machine 304, which may be electrically powered. Snake machine 304 may be configured to drive snake 300 distally and proximally, as desired, while rotating snake 300 about its longitudinal axis. Snake 300, with in-line sonde carrier 100 mounted within sonde carrying section 104, may be inserted into a pipe 400, which may include a blockage 402. Sonde 202, carried within in-line sonde carrier 100, may emit a signal 208, which may be detected by receiver 210 to assist in identifying the location of pipe 400 and/or blockage 402 from above, for example.

FIG. 4 is an elevation view of an example sonde tether assembly 200 including sonde 202, which may be mounted to the distal end of flexible, elongated tether 204. For example, sonde 202 may be connected to the distal end of elongated tether 204 using a split ring 212. In some example embodiments, elongated tether 204 may comprise a flexible coil spring.

Retainer 206 may be mounted to the proximal end of tether 204. In some example embodiments, retainer 206 may be generally cylindrical and/or may be sized to be received within sonde carrier proximal end coupling 102. A reduced diameter distal section 214 may engage the proximal end of elongated tether 204 and/or an expanded diameter proximal section 216 may extend radially outside distal section 214. As described below, retainer 206 may engage sonde carrier proximal coupling 102 to hold sonde 202 in position within sonde carrying section 104.

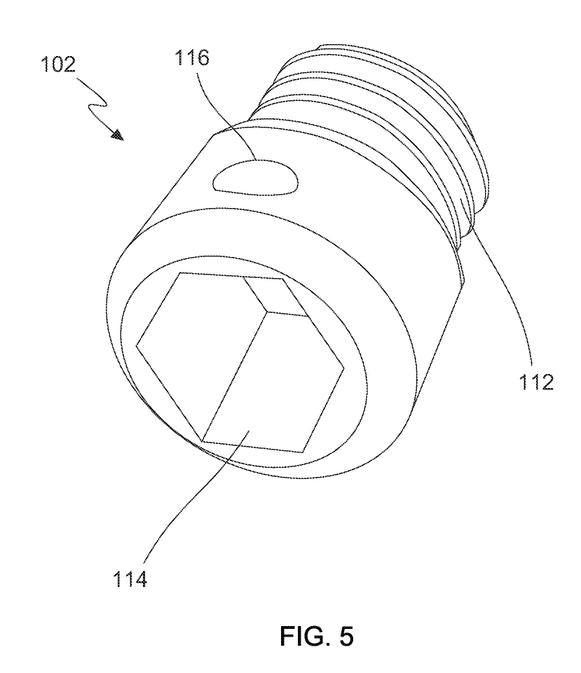

FIG. 5 is a perspective view of an example in-line sonde carrier proximal coupling 102, which may be generally cylindrical. Sonde carrier proximal coupling 102 may include a distal threaded section 112 for engaging the proximal end of sonde carrying section 104, a hexagonal proximal end cavity 114 (facing generally proximally), and/or a generally cylindrical opening 116 extending generally radially into hexagonal proximal end cavity 114.

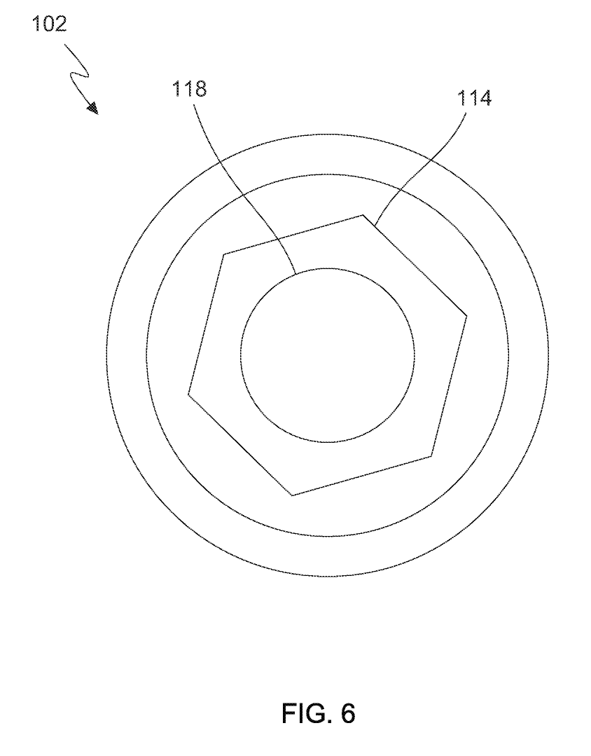

FIG. 6 is a perspective view of an example in-line sonde carrier proximal coupling 102, which may include a circular, axial through-passage 118 extending generally centrally from hexagonal proximal end cavity 114 through threaded section 112 (FIG. 5).

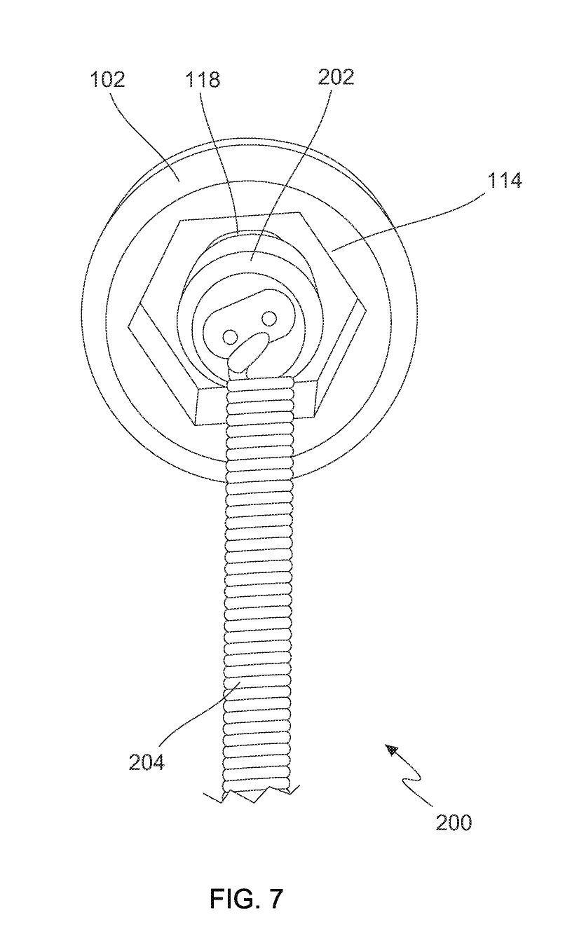

FIG. 7 is a perspective view of an example in-line-sonde carrier proximal coupling 102 with a sonde tether assembly 200 (FIGS. 2 and 4) partially installed. As illustrated, sonde 202 may be inserted through hexagonal proximal end cavity 114 and axial through-passage 118 of sonde carrier proximal coupling 102.

FIG. 8 is a perspective view of an example in-line sonde carrier proximal coupling 102 with sonde tether assembly 200 (FIGS. 2 and 4) fully installed such that only proximal section 216 of retainer 206 is visible in hexagonal distal end cavity 114.

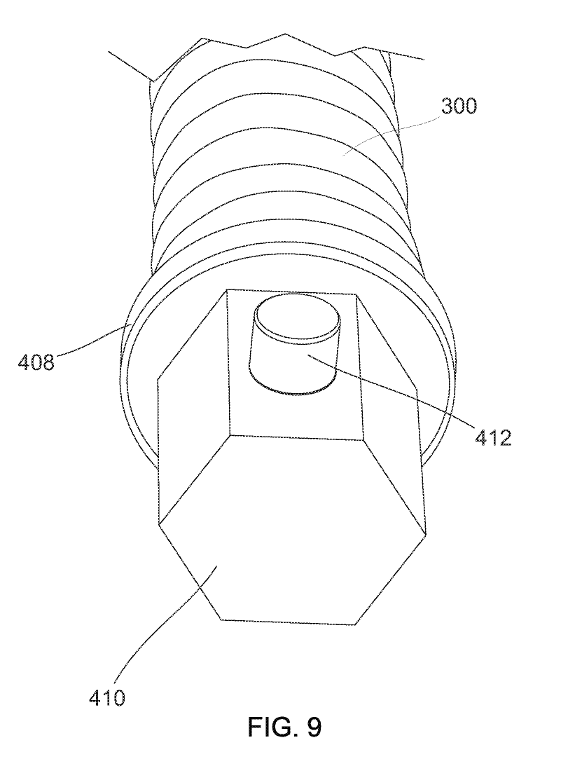

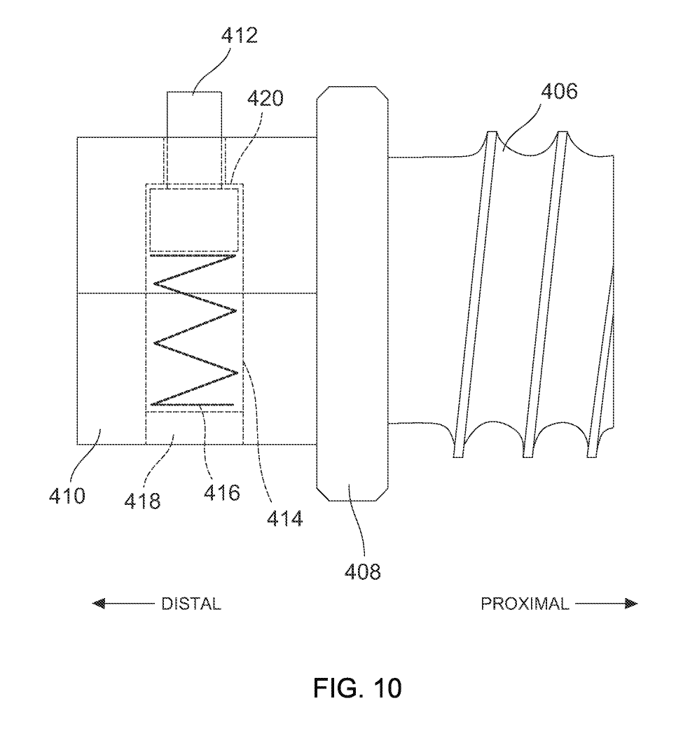

FIGS. 9 and 10 are, respectively, a perspective view of an example snake distal end coupling 302 and an elevation view of an example snake distal end coupling 302. A proximally extending, threaded section 406 may releasably couple with snake 300. A generally cylindrical flange 408 may be disposed distally from threaded section 406 and/or may extend radially beyond threaded section 406. A generally hexagonal section 410 may extend distally from flange 408 such that it may be releasably received in hexagonal proximal end cavity 114 of sonde carrier proximal coupling 102 (FIGS. 5-8). Some example embodiments may include a biased locking pin 412 extending generally radially from hexagonal section 410 such that locking pin 412 may be received within cylindrical opening 116 of sonde carrier proximal coupling 102.

As illustrated in FIG. 10, locking pin 412 may be slidably mounted within a generally diametrically oriented through-bore 414 extending through hexagonal section 410 of snake distal end coupling 302. A bias, such as a helical coil compression spring 416, may be mounted within through-bore 414 and may be configured to bias locking pin 412 radially outwards. In some example embodiments, spring 416 may be captured in through-bore 414 between a cap 418 (which may be threaded into through-bore 414) and locking pin 412, which may be retained by a shoulder 420 in through-bore 414.

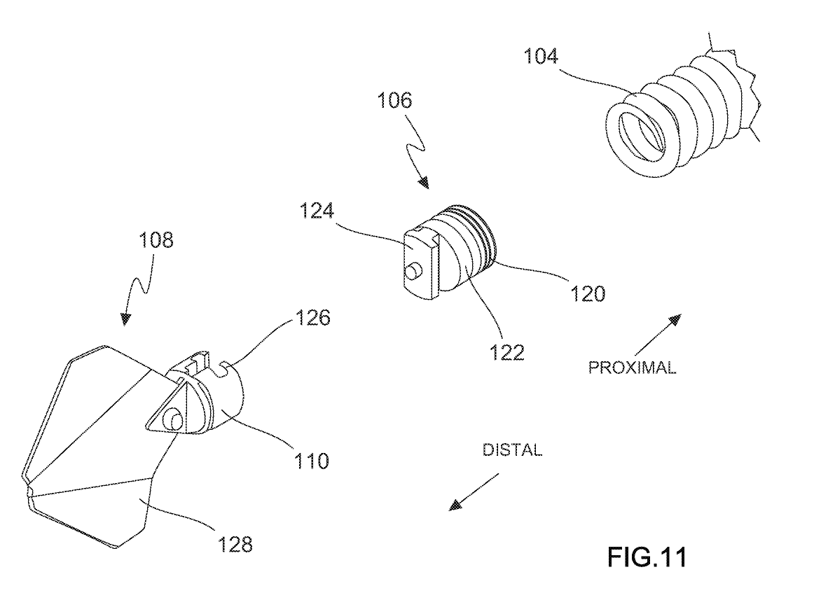

FIG. 11 is an exploded view of an example in-line sonde carrier distal end coupling 106 and tool 108. Sonde carrier distal end coupling 106 may be generally cylindrical and may include a proximally extending, threaded end 120 for releasably engaging the distal end of sonde-carrying section 104. A generally cylindrical flange 122 may be disposed distally from threaded end 120. Sonde carrier distal end coupling 106 may include a distally positioned, diametrically oriented, generally T-shaped boss 124.

Tool 108 may include tool coupling 110, which may include a proximally positioned, diametrically oriented, generally T-shaped slot 126. T-shaped slot 126 may be configured to releasably receive T-shaped boss 124 of sonde carrier distal end coupling 106. Tool 108 may also include, for example, a blade cutter 128 affixed to the distal end of tool coupling 110.

Referring generally to FIG. 3, some example in-line sonde carriers according to the present disclosure may be used as follows. Access to pipe 400 may be obtained, such as by removing a plug from a clean-out fitting. Snake machine 304 may be positioned to drive snake 300 into pipe 400. Sonde 202 may be prepared for use, such as by installing batteries, switching on, etc. Sonde tether assembly 200 may be installed in in-line sonde carrier 100 by inserting sonde tether assembly 200 through sonde carrier proximal coupling 102. Sonde carrier proximal coupling 102 may be connected to snake distal coupling 302 by inserting hexagonal section 410 into hexagonal cavity 114 with locking pin 412 depressed. Once hexagonal section 410 is fully inserted into hexagonal cavity 114, spring 416 may bias locking pin 412 radially outward into cylindrical opening 116, thereby locking sonde carrier proximal coupling 102 to snake distal coupling 302 and/or trapping retainer 206 of sonde tether assembly 200 therebetween. A tool 108 may be installed by joining tool coupling 110 to sonde carrier distal end coupling 106. Snake machine 304 may be operated to drive in-line sonde carrier 100 and snake 300 into pipe 400. Once blockage 402 is reached (or at any time), receiver 210 may be used to detect the position of sonde 202 by receiving signals emitted by sonde 202. Blockage 402 may be reduced and/or cleared by operating snake machine 304 to utilize tool 108 to penetrate, break apart, and/or retrieve blockage 402. Snake machine 304 may be operated to withdraw snake 300 and in-line sonde carrier 100 from pipe 400.

While example embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages of the may exist even though they may not have been explicitly discussed herein.

What is claimed is:

1. An in-line sonde carrier for a plumbing snake, comprising:
a proximal coupling for releasably connecting to a distal end of a plumbing snake, the proximal coupling including an axial through-passage;
an elongated sonde carrying section constructed of coiled metal wire, the sonde carrying section being mounted to the proximal coupling;
a distal coupling mounted to the sonde carrying section;
a tool including a tool coupling configured to releasably engage the distal coupling of the sonde carrying section; and
a sonde tether assembly, including
a retainer shaped to be received and captured within the proximal coupling, and
an elongated, flexible tether coupled to and extending distally from the retainer, the tether being adapted to mount to a sonde extending distally from the tether;
wherein the tether and the sonde of the sonde tether assembly are received within the sonde carrying section via insertion through the axial through-passage of the proximal coupling.

2. The in-line sonde carrier of claim 1, wherein the proximal coupling includes a proximally opening, axially oriented generally hexagonal cavity for receiving therein a corresponding distally extending, generally hexagonal section of a distal coupling of the plumbing snake.

3. The in-line sonde carrier of claim 2, wherein the proximal coupling includes a generally radially oriented, cylindrical opening extending from the hexagonal cavity for receiving therein a spring-biased locking pin extending generally radially from the hexagonal section of the distal coupling of the plumbing snake.

4. The in-line sonde carrier of claim 1,
wherein the sonde carrying section comprises a distal, relatively smaller diameter portion and a proximal, relatively larger diameter portion; and
wherein the tether and the sonde are received substantially within the proximal, relatively larger diameter portion.

5. The in-line sonde carrier of claim 1, wherein the tether comprises a helical coil spring.

6. The in-line sonde carrier of claim 1, wherein the retainer comprises a distal, relatively smaller diameter section sized to be received within the axial through-passage of the proximal coupling and a proximal, relatively larger diameter section too large to pass through the axial through-passage.

7. The in-line sonde carrier of claim 1, wherein the tool comprises a blade cutter.

8. The in-line sonde carrier of claim 1, wherein the proximal coupling and the distal coupling are threadedly engaged with the sonde-carrying section.

9. A plumbing snake system, comprising:
an elongated, flexible plumbing snake including a distal end;
a snake distal coupling mounted to the distal end of the snake; and
an in-line sonde carrier including
a sonde carrier proximal coupling configured to releasably connect to the snake distal coupling,
an elongated, flexible sonde-carrying section extending distally from the sonde carrier proximal coupling,
a sonde carrier distal coupling extending distally from the sonde-carrying section,
a tool including a tool coupling configured to releasably connect to the sonde carrier distal coupling,
a sonde tether assembly including a tether and a sonde received axially within the sonde-carrying section via a through-passage in the sonde carrier proximal coupling.

10. The plumbing snake system of claim 9,
wherein the sonde carrier proximal coupling includes a proximally opening cavity; and
wherein the snake distal coupling comprises a distally extending section configured to be received within the proximally opening cavity of the sonde carrier proximal coupling to releasably connect the in-line sonde carrier to the snake.

11. The plumbing snake system of claim 10,
wherein the proximally opening cavity of the sonde carrier proximal coupling comprises a generally axially oriented, generally hexagonal cavity; and
wherein the distally extending section of the snake distal coupling includes a generally hexagonal section configured to be received within the hexagonal cavity of the sonde carrier proximal coupling.

12. The plumbing snake system of claim 10,
wherein the sonde carrier proximal coupling includes a generally radially oriented opening extending from the proximally opening cavity; and
wherein the distally extending section of the snake distal coupling includes a biased locking pin extending generally radially, the locking pin being configured to be received within the radially oriented opening when the distally extending section is installed within the proximally opening cavity.

13. The plumbing snake system of claim 9, wherein the sonde-carrying section is constructed from coiled metal wire.

14. The plumbing snake system of claim 13, wherein the sonde-carrying section comprises a distal, relatively smaller diameter portion and a proximal, relatively larger diameter portion.

15. The plumbing snake system of claim 14, wherein the tether holds the sonde within the proximal, relatively larger diameter portion of the sonde-carrying section.

16. A method of using a plumbing snake, comprising:
installing a sonde tether assembly including a sonde into an in-line sonde carrier through an axial through-passage in a proximal coupling of the in-line sonde carrier;
connecting the proximal coupling of the in-line sonde carrier to a distal coupling of a plumbing snake, thereby capturing a portion of the sonde tether assembly within the proximal coupling of the in-line sonde carrier; and
inserting the in-line sonde carrier and the snake into a pipe.

17. The method of claim 16, further comprising mounting a tool to the in-line sonde carrier by connecting a tool coupling affixed to the tool to a distal coupling of the in-line sonde carrier.

18. The method of claim 17, wherein the inserting operation includes inserting the in-line sonde carrier and the snake into the pipe until the in-line sonde carrier reaches a blockage in the pipe; and
wherein the method further comprises determining a location of the sonde using a receiver.

19. The method of claim 18, further comprising at least partially clearing the blockage using the tool.

20. The method of claim 16, wherein the connecting operation includes
depressing a locking pin extending generally radially from a hexagonal section extending distally from the distal coupling of the snake;
inserting the hexagonal section into a proximally opening, axially oriented, hexagonal cavity in the proximal coupling of the in-line sonde carrier;
extending the locking pin into a generally radially oriented opening in the proximal coupling of the in-line sonde carrier.
